(19) United States
(12) Patent Application Publication
(10) Pub. No.: US 2008/0034061 A1
(43) Pub. Date: Feb. 7, 2008

(54) SYSTEM AND METHOD OF TRACKING AND RECOGNIZING THE EXCHANGE OF FAVORS

(76) Inventor: MICHAEL BEARES, Washington, DC (US)

Correspondence Address: JUNEAU PARTNERS, P.O. BOX 2516, ALEXANDRIA, VA, 22301, US

(21) Appl. No.: 11/834,686

(22) Filed: Aug. 7, 2007

Related U.S. Application Data
(60) Provisional application No. 60/821,666, filed on Aug. 7, 2006.

(51) Int. Cl. G06F 15/16

(52) U.S. Cl. 709/218

(57) ABSTRACT

A system and method for explicitly building, using, tracking and displaying relationship capital. In one embodiment, the system includes user profile data, a favor recognition system, and favor exchange and rating systems. Each user is able to enter their profile information and exchange favors with other users. The system tracks the exchanges and allows users to provide feedback on the other user's performance. Exchanges are between two users, but can be posted to multiple users. The giver of a favor receives credits to their account and the receiver's account is debited for the equivalent amount. The system stores and displays the user's transaction history and provides a summary which includes the favor balance and feedback summary. Relationships between different users are defined by their exchange history.

### PRIORITY APPLICATION

This application claims benefit under 119(e) to U.S. Provisional 60/821,666 filed 7 Aug. 2006.

### BACKGROUND

1. Field of the Invention

The present invention relates to an internet service, and in particular, a networking platform focused on favor exchange and networking activities. The invention tracks the exchange of favors among users of the service, allowing members to build relationship capital and meet their networking goals.

2. Description of the Prior Art

With the growth of the internet, a number of services have developed to extend the benefits of social networking into the online area. Some of these services focus on a specific function such as business networking (e.g. linkedin.com) or dating (e.g. match.com), while others are more general and have a mix of shared interests, friendship and dating (e.g. friendster.com, myspace.com). These services allow users to build profiles about themselves that can include a range of information from profession, company, university, networking goals, musical interests, dating preferences, etc.).

A number of services, particularly those focused on professional relationships (e.g. LinkedIn, Xing, etc.) also use network linkages as a key element of the profile and service. This is based on two popular concepts 1) that you can tell a lot about a person based on the friends that he/she keeps and 2) that there is no more than six degrees of separation between any two people. Users are able to establish links with other users and these links become a visible component of their online profile and reputation.

In addition, the links provide visibility into a users extended network (e.g. friends of friends of friends) and a communication channel to reach these users (e.g. a request for a job interview can be past via several links to a hiring manager).

A disadvantage to this approach is that there is a mismatch between parts of the network that can provide the most value and their incentive to help. The most valuable parts of a network are in the outer edges. First, the number of network members goes up as one includes more distant relationships (weak tie relationships and relationships with more degrees of separation). Second, the value of information held by more distant members may be higher as described by sociological concepts of “strength of weak ties” and “structural holes”. Close ties tend to be with people who have similar backgrounds (e.g. socioeconomic status, education, jobs, etc.) and thus limited new information. Our more distant relationships include more people with different backgrounds and thus more new information.

At the same time, the propensity to provide a favor declines at the outer edges of the network. First, the credibility of the profile, including formalized links and specific endorsements, declines at the more distant edges of the network. Second, the incentive to help declines at the edges because of weak or non existent norms of reciprocity and no explicit reputation building mechanism for providing assistance. Sociologist are not in full agreement as to why people provide favors, but most agree that reciprocity and recognition frequently play a key role.

This mismatch between the network value of users and their propensity to help manifests itself in a number of ways including the following:
Slow response times in requests that have to be passed from one user to the other
Low response rates to activity requests
Hesitancy of users to request favors from other users

In summary, the prior art in online business networking is focused on the popular concept that “success is often driven not by what you know, but who you know” and leveraging “six degrees of separation”. Our invention takes a different approach by focusing on incentives (generalized exchange) and more relevant profile information (feedback on networking favors). In essence, we believe “success is often driven not by what you know, or who you know, but by what ‘who you know’ will do for you”.

Prior art in the social networking area includes the following:

U.S. Pat. No. 6,175,831 discloses a networking database containing a plurality of records for different individuals in which individuals are connected to one another in the database by defined relationships. Each individual has the opportunity to define the relationship which may be confirmed or denied. E-mail messaging and interactive communication between individuals and a database service provider provide a method of constructing the database. The method includes having a registered individual identify further individuals and define therewith a relationship. The further individuals then, in turn, establish their own defined relationships with still other individuals. The defined relationships are mutually defined.

U.S. Pat. No. 7,069,308 discloses a method and apparatus for calculating, displaying and acting upon relationships in a social network. A computer system collects descriptive data about various individuals and allows those individuals to indicate other individuals with whom they have a personal relationship. The descriptive data and the relationship data are integrated and processed to reveal the series of social relationships connecting any two individuals within a social network. The pathways connecting any two individuals can be displayed. Further, the social network itself can be displayed to any number of degrees of separation. A user of the system can determine the optimal relationship path (i.e., contact pathway) to reach desired individuals. A communications tool allows individuals in the system to be introduced (or introduce themselves) and initiate direct communication.

United States Patent Application 20060009994 discloses a system and method for reputation rating. The method discloses: collecting a set of reputation ratings on a target entity from a set of reputation rating entities; attributing a weight to each of the reputation ratings based on a set of filtering criteria; and combining the weighted reputation ratings to generate a filtered reputation rating with respect to the target entity. The system discloses various means, mediums and systems for effecting the method.

United States Patent Application 20060122974 discloses a system and method for a dynamic content driven rendering of social networks. A search request is received at an information retrieval system. A repository of objects are searched for relevant objects based upon the search request. Parties are identified as parties who interacted with or are mentioned within the relevant objects. A relation score is determined for each pair of parties. A map is created based upon the relation scores of all the pairs of parties. The map is displayed such that the relation scores of the pairs of parties are shown. The determination of the relation score can be weighted by each relevant object's relevancy score. The relation score can also be dependent upon the each party's interactions with or mentions within the relevant objects, and the time lapse between one party's the interaction with or mention within a relevant object, and that of another party.

United States Patent Application 20050256756 discloses a system and method for utilizing social networks for collaborative filtering. A novel system and method of predicting a user's rating of a new item in a collaborative filtering system is described. The invention incorporates social network information in addition to user ratings to make recommendations. The distance between users in the social network is used to enhance the estimate of user similarities for collaborative filtering. The social network can be constructed explicitly by users or deduced implicitly from observed interaction between users.

United States Patent Application 20050216300 discloses sharing social network information. Social network information may be shared across online service providers. Thus, one online service provider M that maintains a membership separate from a second online service provider N may nevertheless use the social network maintained by the second online service provider N to tailor content and/or services based on such social network information.

There are other areas of related art where alternative currencies (e.g. frequent flier points) are used as incentives to drive behavior. Different to our method, most of these incentives are associated with a financial transaction (e.g. frequent flier miles after a commercial flight or credit card points after a purchase).

A few examples of prior art in the area of online questions and answers are not associated with a financial transaction (e.g. ExpertsExchange and Yahoo Answers). Different to our method, these systems are focused on providing answers that are published on the internet. Much of the information or actions in our method (e.g. introductions, meetings, etc.) are not captured in an online response.

Other examples of prior art include U.S. Pat. No. 6,064,978 that discloses a method for regulating the asking and motivating the answering of questions via a computer network. The number and complexity of questions asked is controlled by a question regulation method, and the number and quality of answers provided is controlled by an answer evaluation method. The question regulation method permits users to post more numerous or more complex questions based on factors such as viewing of advertising, or provision of marketing information. The answer measurement method may be used to reward those who supply numerous or high-quality answers with premiums, public recognition, or employment opportunities.

U.S. Pat. No. 6,965,868 discloses a personal communication and electronic commerce system for use by participating users and participating merchants in connection with incentive programs in the Network Economy. The system includes a cellular communication network that includes geographically spaced base stations that are linked to a fixed communication network. Users may have personal communication devices that can be used to allow a digital message generated on the personal communication devices by placing a call through one of the base stations and memory for storing a digital value corresponding to a monetary value. The personal communication device may also be used as a cellular position locator to determine one's geographic location and, if desired, to access information from a merchant information database containing information pertaining to a plurality of participating merchants located within the geographic territory covered by the cellular communication network. The merchant information may be stored on a database that is accessible by merchants so those merchants can add, delete or alter information contained in their respective listings. An incentive system is also provided for creating incentives for participating users to encourage. This computer implemented incentive program for encouraging certain participant actions includes a first reward program under which participants may earn points for certain actions and a second reward program through which the redemption rate associated with a particular participant is adjusted in response to certain participant action. The incentive program has a wide range of applications, including transportation, financial services and computer gaming.

### SUMMARY

Current business oriented social networking focus on “connections”, e.g. friends of friends of . . . , etc., and linking to trusted actors through a chain of “connections” to get networking favors, e.g. information, introductions, meetings, etc. The present invention focuses on the “actions” i.e. making introductions, giving of information, etc., rather than connections. The system is embodied as a favor recognition bank that tracks 1) the favors given and received and 2) feedback provided for each of the exchanges. Users are able to build relationship capital by giving favors and use their relationship capital by requesting and receiving favors.

Accordingly, the present invention provides in one preferred embodiment a method for exchanging and recognizing favors in an online system, the method comprising: collecting user data from every user in the online system, said user data including i) a professional profile of each user, ii) relationship capital data comprising information about exchange of favors within the system; storing said profile and said relationship capital data; calculating a favor balance from the relationship capital data; and displaying a relationship capital summary.

The method also further comprises: inviting a new user outside the system to join the system; and collecting user data of said new user.

Another preferred embodiment provides a favor exchange and recognition system for connecting a first user to a second user, the system comprising: a first user interface device; a second user interface device; a network coupled to said first user device and said second user device; a server connected to said network, said server having: a database storing user data of every user, said user data including i) a professional profile of each user, ii) relationship capital data comprising information about exchange of favors within the system; and said server calculating a favor balance from the relationship capital data; and said server transmitting display information about the favor balance to the first user interface device and the second user interface device.

The system also further comprises: a mail server coupled to said database and said server, said mail server communicating with the first user and the second user via said network.

The system also further comprises wherein said server further comprises: a web application server communicating with said network, said web application server soliciting said user data from said users and inviting other users outside the system to join the system.

A further preferred embodiment provides computer readable media containing a program of instructions for performing a method for exchanging and recognizing favors in an online system, the method comprising: collecting user data from every user in the online system, said user data including i) a professional profile of each user, ii) relationship capital data comprising information about exchange of favors within the system; storing said profile and said relationship capital data; calculating a favor balance from the relationship capital data; and displaying a relationship capital summary.

Yet another preferred embodiment provides a method for displaying relationship capital data about users in a system, comprising: i) receiving user data from a plurality of user interface devices; ii) storing said user data on a server; iii) calculating a favor balance from the relationship capital data of each user; iv) transmitting said favor balance to said plurality of user interface devices; and v) displaying said favor balance on said user interface devices.

The method also further comprises, wherein at least one of the steps of said method further includes communicating over a network.

The method also further comprises, wherein the relationship capital data comprises professional profile data that consists essentially of first and last name, job function, employer name, country of residence, and networking requirements.

The method also further comprises, wherein said relationship capital data further includes comments or opinions of any said user regarding any other said user.

The method also further comprises, wherein said relationship capital data further includes gift information selected from whether a gift has been made from one user to another user, or whether a gift has been made to a non-profit organization.

The method also further comprises, wherein said communication system is selected from the group consisting of an internet webpage, e-mail, instant messaging, telephone, wireless telephone, internet voice communications, or video communications.

Yet a further preferred embodiment provides a computer implemented process for identifying one or more persons having a specific attribute, comprising: i) accessing a database having professional profile information and favor balance information about users in a favor exchange and recognition system; ii) comparing the specific attribute against the professional profile information and favor balance information; and, iii) identifying a match between the attribute sought and the user information.

Another preferred embodiment provides a web service for integrating a web-based application for exchanging and recognizing favors into an existing social networking service, comprising: a server connected to a network having programming to provide favor exchange and recognition information which comprises favor balance data to one or more social networking services, wherein the web service acts as a central favor recognition bank and feedback consolidator.

The web service also further comprises, wherein the social networking service is selected from LinkedIn, Friendster, Xing, My Space and Face Book

A further preferred embodiment provides a user interface device for peer to peer exchanging and recognizing favors, comprising: means for communicating user data between a plurality of user interface devices; ii) means for storing said user data on the user interface devices; iii) means for calculating a favor balance from the relationship capital data of each user; iv) updating each users favor balance on each user interface device; and v) means for displaying said favor balance on said user interface device.

The user interface device also further comprises: a mail server coupled to said database and said server, said mail server communicating with the plurality of user interface devices.

The user interface device also further comprises wherein said server further comprises: a web application server communicating over a network.

### BRIEF DESCRIPTION OF THE FIGURES

FIG. 1 is a Summary Flowchart. FIG. 1 shows an overview of the key processes.

FIG. 2 is a System Diagram. FIG. 2 illustrates key elements of the system.

FIG. 3 is a Favor Exchange (Individual) Flowchart. FIG. 3 illustrates the process for a user to request a favor of another user.

FIG. 4 is a Favor Exchange (Group) Flowchart. FIG. 4 illustrates the process for a user to post a request to a group.

FIG. 5 is an Invention Overview. FIG. 5 illustrates the key components of the invention.

FIG. 6 is a Partial Screenshot of a User Home Page. FIG. 6 illustrates a sample user Home Page, the user's Relationship Capital, and Inbox/Pending Actions.

FIG. 7 is a Partial Screenshot of a User Profile Page. FIG. 7 illustrates the type of information provided to the user community on each user.

### DETAILED DESCRIPTION OF THE PREFERRED EMBODIMENTS

Introduction

Success in many activities is contingent on one's ability to extract resources from a social network, commonly called Social or Relationship Capital. The invention is comprised of a system and method to aid users to network over the internet and build and use relationship capital.

Networking and relationship capital can be vital to a range of activities from professional tasks to charitable work and personal activities. Resources available via social networks range from information, to financial capital and a number of other assets. Examples vary from a friend informing you of a previously unknown job opening to a neighbor lending a car.

The key determinants of one's social or relationship capital are 1) access to individuals, 2) the assets of the individuals and 3) the individual's willingness in lending or giving the assets. The invention, different to prior art, explicitly addresses all three elements.

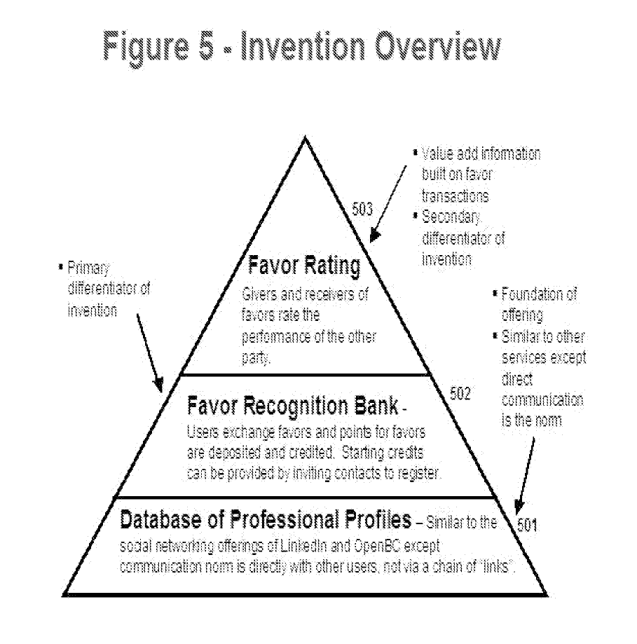

The invention is comprised of three conceptual components as illustrated in FIG. 5. The foundation is a searchable database of profiles of the users 501. On top of the profile database is a favor recognition bank and exchange system 502. Finally, a rating system 503 is provided to compile and present feedback on the favor exchanges.

Definitions

Degrees of Separation. The number of reciprocal connections (see definition below) linking any two individuals in the social network. The number of degrees is equal to the number of individuals in the chain minus one. For example, if User A is connected to User B who is connected to User C, then User A and User C have 2 degrees of separation.

Favor. Activity or help provided by one user to another user. Examples include sharing information, participating in a meeting or conference call, or making an introduction.

Favor Point. A measure used to quantify the exchange of favors.

Favor Size. A measure used to quantify the size of a favor exchanged.

Favor Recognition Bank. Storage and display of favors given, received and the favor balance.

Favor Status. The status of a favor transaction (e.g. accepted, pending, completed, etc.)

Feedback. Numerical ratings and qualitative comments provided by one member on the performance of a favor exchange.

Group. A plurality of Users electing to register a specific affiliation (e.g. University alumni group). Each group has communication tools restricted to the group members.

Group Members. Individual Users that have registered with a group.

Internet. A collection of interconnected (public and/or private) networks that are linked together by a set of standard protocols (such as TCP/IP and HTTP) to form a global, distributed network. This may include future variations of the internet or its protocols.

Invitation. A message from a user to another individual suggesting they register with the system

User Information. Information that the user submits about him or herself. Profile data can include elements such as user first and last name, job function, company, country of residence and networking needs.

Quantitative Feedback. A numerical value used for feedback on a favor that is applied to a individual favor and then used to summarize all favor feedback for a specific user.

Reciprocal Connections. A connection between any two users established after a favor exchange.

Relationship Capital Data. Information about the exchange of favors on the system. This can include favors given, favors received, favor balance, and feedback.

Social Network. An aggregation of individual social relationships.

User. An individual who has registered in the system.

User Interface. Any mechanism through which an individual or computer can send and receive data to the server and database system of the invention. The most common example being a web site or page, but includes email and other methods.

Web Services. Web services describes a standardized way of integrating Web-based applications using the XML, SOAP, WSDL and UDDI open standards over an Internet protocol backbone. Web services share business logic, data and processes through a programmatic interface across a network. Developers can then add the Web service to a GUI (such as a Web page or an executable program) to offer specific functionality to users.

Web Site. A computer system that serves informational content over a network using the standard protocols of the World Wide Web.

Materials

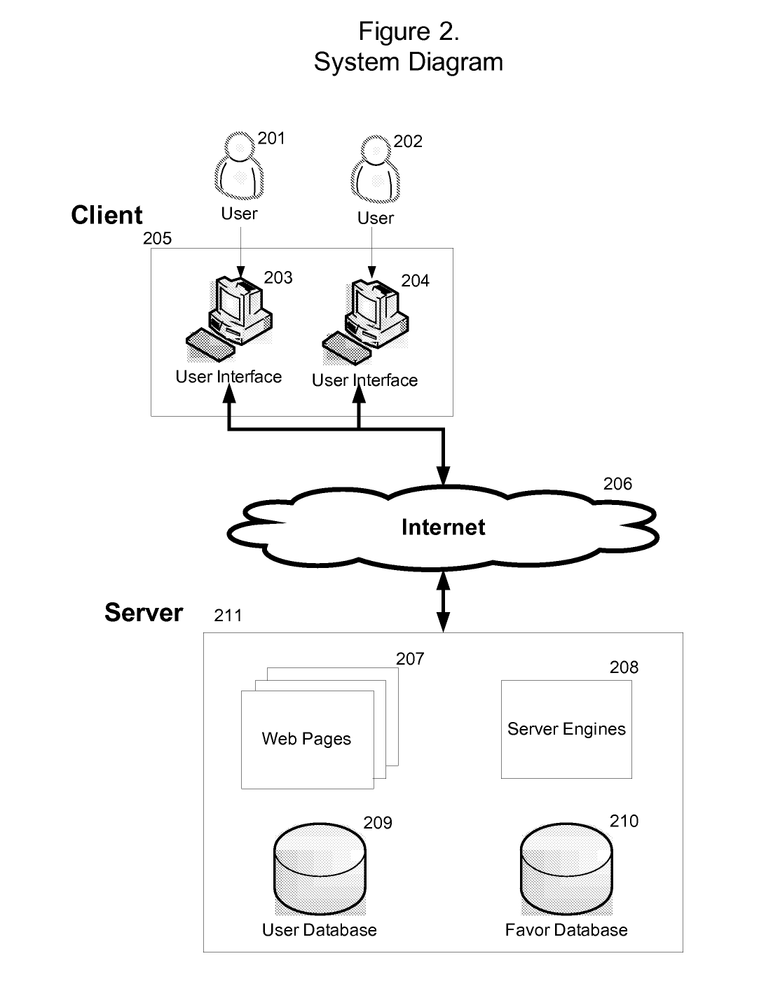

FIG. 2 illustrates the general architecture of the system. The invention is based on a client 205 server 211 architecture connected via the internet 206. A plurality of users 201 and 202 employ a plurality of user interfaces 203 and 204 which connect to the internet 206 and then to the server system 211. The server system includes databases 209 and 210, server engines 208 and web pages 207. Those skilled in the art can envision other embodiments that could include additional components such as routers, switches, firewalls, load balancers and other components common to a web based server systems.

The User Interface 203 and 204 include any device capable of presenting data, including, but not limited to, computers, cellular telephones, television sets or hand-held devises such as personal digital assistants (PDAs).

The apparatus 211 is connected to the internet. A number of additional components may support the connection including, but not limited to routers, switches, load balancers, and firewalls.

The apparatus 211 contains one or a plurality of databases 209 and 210. The databases store all information for the apparatus including user information, favor information, software, digital images, and system data. Databases are will recognized by those proficient in the relevant arts. Examples include MySQL, Oracle, DB2 and Access. The databases 209 and 210 can be accessed via a Structured Query Language (SQL) or other tools known to one of skill in the art. Those proficient in the relevant art my envision other embodiments where the data is combined into one or a plurality of databases.

The apparatus 211 includes a plurality of server engines 208. The server engines may include, but are not limited to computer server(s), application server(s), image server(s), mail server(s), web server(s), and database server(s).

The Web Pages 207 are sent out by the apparatus 211 in response to Hypertext Transfer Protocol (HTTP) requests by users 201 and 202 via remote User Interfaces 203 and 204. The Web Pages 207 are then displayed as a graphical user interface on the User Interface 203 and 204 and support the exchange of data with the apparatus 211.

Methods

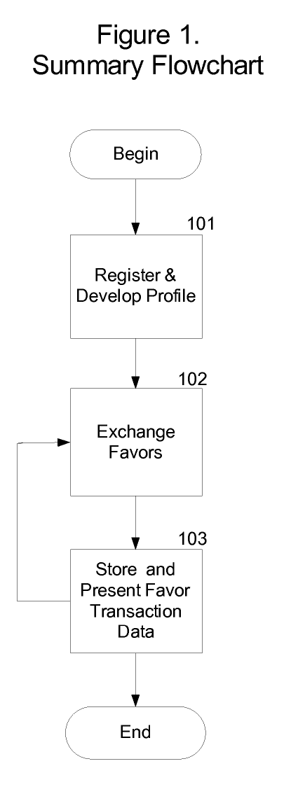

FIG. 1 provides a summary flowchart. An individual can register as a user at the website and optionally develop a more detailed profile 101. The User then is able to exchange favors with other Users 102. Records of the favor transactions are then stored and presented to Users 103. The information profile and presentation of favor transaction data builds trust to facilitate further favor exchange.

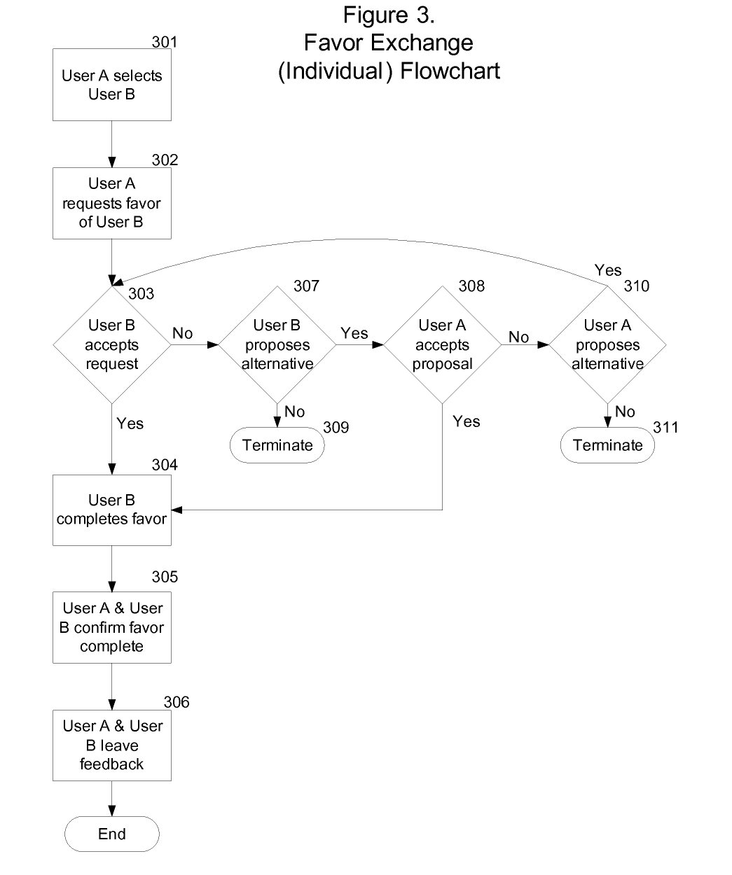

FIG. 3 is a flow chart that provides further detail on the method for exchanging favors, in particular a favor requested of an individual user. The method begins with step 301 where User A selects another User to request a favor (User B). User A can select User B by browsing user profiles, using simple or advanced search functionality, or selecting a user from their My Contacts List.

Once User A selects User B, he/she can request a favor 302. User A fills out a request form including the following: type, subject, need by date, favor size, and description of the request. The request is emailed and/or posted to User B's In Box.

User B now decides whether to accept the request 303. Alternatively, User B can decline the request 309 or propose an alternative 307. The alternative can include a different due date, favor size, subject and/or a qualification. If User B proposes an alternative, User A decides whether to accept 308, propose another alternative 310, or decline 311. If User A proposes another alternative, the flow returns to User B making a decision to accept 303.

Once both User A and User B accept, User B completes the favor 304. The favor could range from providing information on a job opening, to insight into a sales opportunity or an introduction. Once the favor has been completed User A and/or User B confirm the favor has been completed 305 and leave feedback 306. Feedback is comprised of a numerical rating and written comments.

Following the completion of a favor User A may elect to provide additional recognition to User B by giving a gift or making a donation to a not-for-profit on behalf of User B. The basic process followed by User A is as follows:
User A selects to either provide a gift or make a donation.
User A selects the partner company providing gifts or the not-for-profit
User A selects the gift or donation amount
In the case of the gift, the apparatus confirms the gift inventory via a communication with the partner company inventory systems and confirms the item is in stock to User A
User A submits payment information
Apparatus transmits order and associated User B data (name and address) to partner or not-for-profit
Recognition for the gift or donation are indicated on the feedback of both User A and User B

During the favor exchange process, the system tracks the favor status. After each communication action by a user (e.g. acceptance of the favor), the status is updated and displayed to both members.

One could envision an example of the above method as follows: A sales person selling market research is trying to sell to a Fortune 500 company. The sales person is new to the account and has no relationships at said company and does not know who the buyers could be. The sales person (User A) registers at the invention and searches for users working in the marketing department at said company. Upon finding another user in an appropriate position (User B), the sales person sends a favor request asking for a conference call to learn more about said company's market research needs.

User B receives the request and based on her knowledge of the company's needs and interest in developing relationship capital, accepts the request. The conference call is conducted and User B shares with User A the market research needs of said company and provides a recommendation for next steps. Both User A and User B return to the user interface and indicate the favor is complete and leave feedback of a numerical rating and qualitative comments. The system then debits the favor account of User A, credits User B and updates their feedback ratings.

Another example could include User A requesting or accepting a favor outside of the system. User A could then use the system to recognize the favor by giving User B favor credit and leaving feedback. One could envision an example as follows: User A above meets User B at a conference. User A verbally requests some information of User B and User B complies. At a later time, User A logs onto the system and indicates User B has provided a favor. User B is credited with the appropriate number of favors and User A is debited an equivalent amount. Both users can then input feedback on the favor exchange.

Yet another example could entail User A requesting or accepting a favor from a person not registered with the system (Person B). After requesting or receiving the favor, User A could send Person B, via the system, an invitation to register which would include a favor credit(s). Person B could register and their new account would be credited with the favor credit(s) and User A's account would be debited. One could envision an example as follows: User A meets Person B at a conference. User A requests some information from Person B and she complies. User A wants to recognize Person B's favor and build the reciprocal relationship. User A logs into the system, selects the send an invitation function, inputs Person B's email address, enters a personal note, and submits the invitation. The apparatus issues Person B an invitation and sends it to Person B via email. Person B receives the email and registers with the system. Person B, now User B, is credited with the favors and User A is debited with the equivalent amount. Both Users are also able to leave feedback.

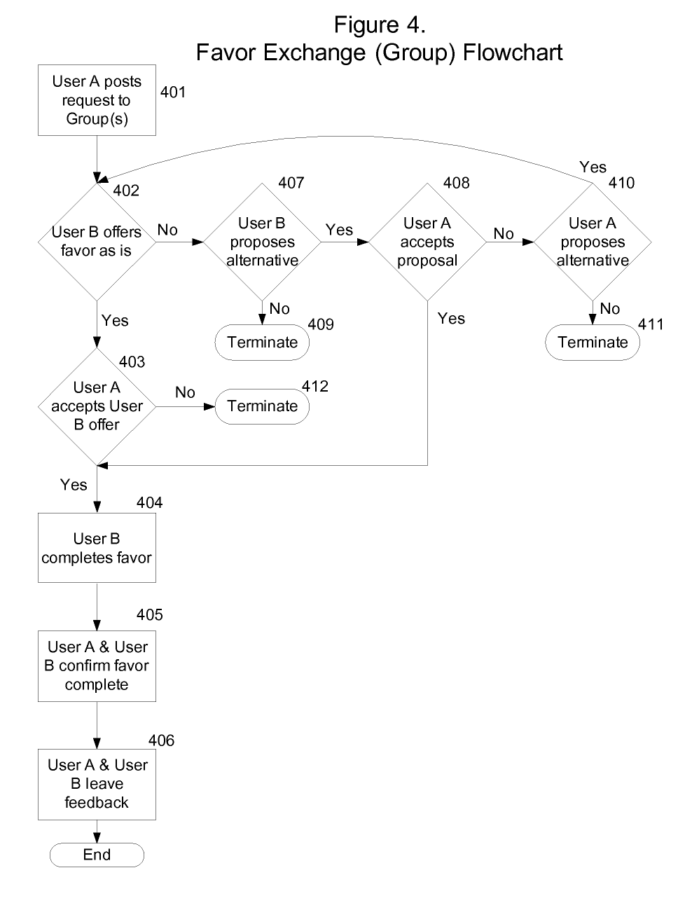

FIG. 4 is a flow chart that provides further detail on the method for exchanging favors, in particular a favor posted to a group of Users. The group of Users could include all Users registered on system or a subset defined by group membership (e.g. Users registered with the systems Columbia University alumni group) or an algorithm (e.g. all users with a favor balance >10). The method begins with step 401 where User A fills out a request form including the following: type, subject, need by date, favor size, and description of the request. User A then selects the appropriate group(s) and/or screening algorithms to define the users able to see and respond to the request. The request is emailed to group members and/or posted on the web site in areas visible to the members.

Members of the group can elect whether to respond to the request and if so whether to accept as is 402, propose an alternative 407, or not respond 409. The alternative can include a different due date, favor size, subject and/or a qualification. If the group members responding (User B) proposes an alternative User A decides whether to accept 408, propose another alternative 410 or decline 411. If User A proposes another alternative the flow returns to User B making a decision to accept 402. Note there may be more than one User B.

If User B offers to complete the favor 402 as described in 401, User A has the option to accept or decline 403. If User A does not accept 403, the interaction with User B is terminated 412.

Once both User A and User B accept, User B completes the favor 404. The favor could range from providing information on a job opening, to insight into a sales opportunity or an introduction. Once the favor has been completed User A and/or User B confirm the favor has been completed 405 and leave feedback 406. Feedback is comprised of a numerical rating and written comments.

Following the completion of a favor User A may elect to provide additional recognition to User B by giving a gift or making a donation to a not-for-profit on behalf of User B. The basic process is detailed above in the description of a favor requested of an individual.

During the favor exchange process, the system tracks the favor status. After each communication action by a user (e.g. acceptance of the favor), the status is updated and displayed to both members.

One could envision an example of the above method as follows: A business person (User A) is in the process of selecting an outside vendor for an important contract. User A has reviewed the vendors marketing materials and references but is still not sure if the vendor is a good choice. User A would like a few unbiased references, but is not sure of who to ask. User A logs onto the system, selects the request a favor function and describes the request including favor size, due date, subject and a description of the information requested (e.g. personal experiences with the vendor). User A has previously registered as a member of a University alumni group and decides to post the request to this group. All members of the alumni group are able to view the request and elect to respond.

In this example, three group members decide to respond. The first two communicate to User A that they have personal experience and are happy to discuss their experience with the vendor. The third group member indicates experience in an irrelevant area. User A accepts the offers from the first two group member and declines the third.

User A conducts a phone conversation with the first group member and receives the requested feedback. User A then logs into the system, indicates the favor is complete and both User A and the first group member leave feedback.

Alternatively, the second group member elects to send User A an email describing her experience. User A finds the information helpful and then logs onto the system and indicates the favor is complete. Both User A and the first group member leave feedback.

Another similar example includes a business person (User A) in a similar situation (needing independent feedback on a vendor). In this case, rather than posting the request to an Alumni group, User A wants to post to active favor givers. User A selects screening criteria of all members with a favor balance greater than 20. In this example, only Users with a favor balance of greater than 20 will be able to view and respond to the request.

In the current embodiment Users will be able to invite other people to register with the system. Users will be incented to invite other people to register by being recognized with favors credited to their balance. The basic process will be as follows:
User A enters one or more names and email addresses. The names and email addresses may be entered manually or uploaded from a contact manager (e.g. Microsoft Outlook, Yahoo Mail, Gmail, etc.) or external file (e.g. CSV file).
User A can enter a personal invitation or use invitation templates (e.g. “I have started using a great new networking tool and thought you might be interested. If you register, either I or someone else in the network would be happy to do you favor.”)
User A submits the invitation and email message(s) is/are sent to the address(es).
The person/people receiving the invitation(s) can either register or not register
If a person registers, a User account is established and the account is credited with one or more favors. The account of User A is also credited with one or more favors.

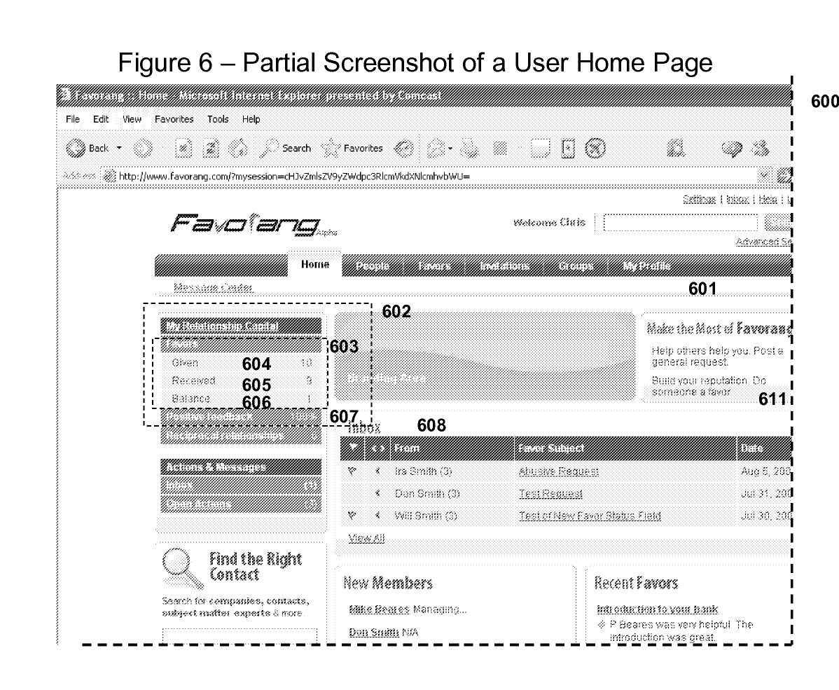

FIG. 6 is a Partial Screenshot of a User Home Page and illustrates the method of displaying a User's Relationship Capital. The User Home Page 600 is generated by the Server apparatus 211, transmitted over the Internet 206 and displayed on User Interfaces 203 and 204. The current embodiment of the User Home Page has a number of key elements including the Main Navigation bar 601, “My Relationship Capital” 602, and “In Box” 608. The User Home Page 600 may also include other secondary elements as illustrated by “Make the Most of”. 611.

“My Relationship Capital” 602 is composed of several elements. The first is a summary of favor transactions or the favor recognition bank 603. The favor recognition bank summarizes the favors credited for giving favors 604, the favors debited for receiving favors 605 and the Balance 606. The Balance 606 is calculated by subtracting the favors debited from the favors credited.

The final element in “My Relationship Capital” is a summary of quantitative feedback 607 illustrated as “Positive Feedback”. Both quantitative and qualitative feedback is provided by other users at the conclusion of a favor exchange. In this embodiment, the qualitative feedback is provided on a 3 point scale of either a) positive, b) neutral, or c) negative. The quantitative feedback summary 607 is a percentage of the transactions where the User has received positive feedback. Those familiar with the art can envision quantitative feedback in other formats (e.g. a 5 point scale).

“In Box” 608 includes communications between the User of the User Home Page 600 (User A) and other Users (User B).

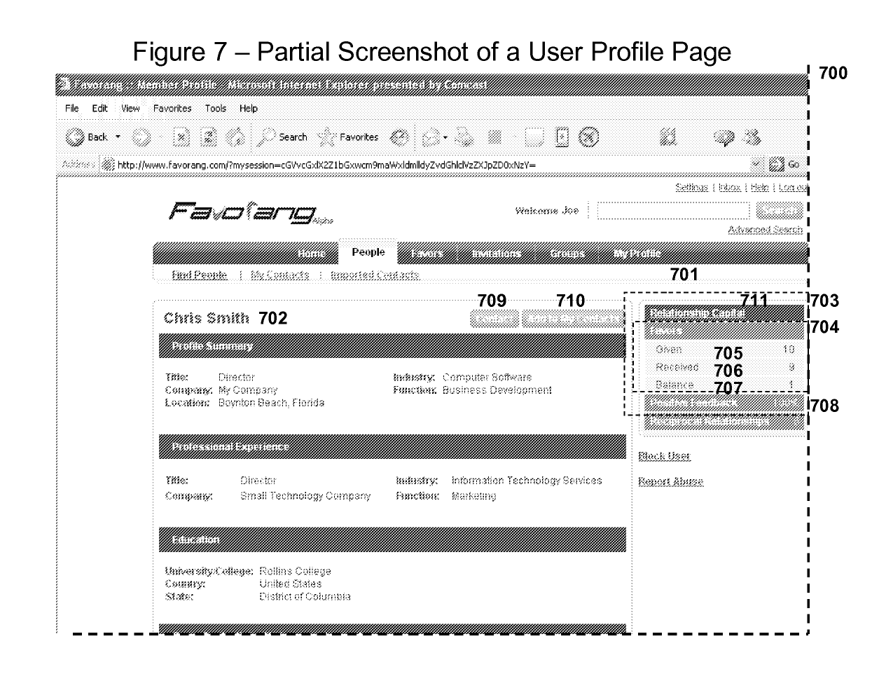

FIG. 7 is a Partial Screenshot of a User Profile Page and further illustrates the method for displaying a User's Relationship Capital. The User Profile Page 700 provides a summary profile of a User (User A) to a plurality of other Users (User B). The User Profile Page 700 is generated by the Server apparatus 211, transmitted over the Internet 206 and displayed on User Interfaces 203 and 204. User B can navigate to the User Profile Page 700, by using the searching or advanced searching function or simply browsing through User Profiles.

The current embodiment of the User Profile Page has a number of key elements including the Main Navigation bar 701, “User Profile” 702, and “Relationship Capital” 703. The User Profile Page 700 may also include other secondary elements as illustrated by Contact 709 and Add to My Contacts buttons 710.

The User Profile 702 displays profile information provided by User A. In this embodiment, the User Profile 702, includes the following data elements: First Name, Last Name, Company, Industry, Function, Location, Former Positions, and Education.

The Relationship Capital element 703 is similar to that displayed on the User Home Page 602. The first is a summary of favor transactions or the favor recognition bank 704. The favor recognition bank summarizes the favors credited for giving favors 705, the favors debited for receiving favors 706 and the Balance 707. The Balance 707 is calculated by subtracting the favors debited from the favors credited.

The final element in “Relationship Capital” a summary of quantitative feedback 708 illustrated as “Positive Feedback”. Both quantitative and qualitative feedback is provided by other Users at the conclusion of a favor exchange. In this embodiment, the qualitative feedback is provided on a 3 point scale of either a) positive, b) neutral, or c) negative. The quantitative feedback summary 708 is a percentage of the transactions where User A has received positive feedback.

Users are also able to view further detail on the relationship capital 703 of User A. By selecting the Relationship Capital Link 711, a User will be presented with details on the favors completed by User A. In this embodiment, the information available will include the type, favor subject, favor size, favor completion date, name of favor giver, name of favor receiver, quantitative feedback rating, qualitative feedback comments, an indication (icon or text) that a gift was given or received or a donation given or received.

Users are also able to screen other members from contacting them. Users can select from a range of screening criteria include the following:
Profile information including Industry, Function and Company
Geographic information including Country
Favor Exchange history which includes the following elements:
   Positive feedback i.e. the percentages of feedback ratings that are positive
   Favor Balance i.e. the total when subtracting the favors given from the favors received
My Groups i.e. groups the User is a registered member

For example, a User wanting to limit requests to members of his industry, alumni group and those with a favor balance over 10 can block communication from all other members. User A accesses the Settings section of the site, selects their industry from the industry list, alumni group from their “my groups” list and selects >10 from the favor balance menu.

One familiar with the art can also envision an embodiment where the system operates as a web service and provides favor exchange, favor recognition bank, and feedback consolidation services to other web sites (e.g. operate similar to a paypal for favor recognition). The apparatus serves as a central favor recognition bank and feedback consolidator. In the context of other websites, Users can exchange favors, and give and receive feedback and have the associated information consolidated with the invention.

An Example Could Proceed as Follows:

User A is an avid user of Social Networking Service (SNS) X, but has also recognizes the value of the invention and is a registered user. SNS X integrates the apparatus web service with their web site. User A logs into SNS X and is able to view their Relationship Capital 602 and other Users are able to view User A's Relationship Capital 703. Favors can be exchanged on SNS X and the favor debits and credits, and feedback are consolidated via the web service on the apparatus.

It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

What is claimed is:

1. A method for exchanging and recognizing favors in an online system, the method comprising: collecting user data from every user in the online system, said user data including i) a profile of each user, ii) relationship capital data comprising information about exchange of favors within the system; storing said profile and said relationship capital data; calculating a favor balance from the relationship capital data; and displaying a relationship capital summary.

2. The method of claim 1 further comprising: a communication process for a user to request a favor from another user and use that process to accept, decline, negotiate alternatives, and indicate completion.

3. The method of claim 1 further comprising: the display of the favor status based on the user actions in the favor exchange process.

4. The method of claim 1 further comprising: the display of numbers of favors given, received and the favor balance.

5. The method of claim 1 further comprising: the display of quantitative feedback metrics based on feedback given on the exchange of favors.

6. A favor exchange and recognition system for connecting a first user to a second user, the system comprising: a first user interface device; a second user interface device; a network coupled to said first user device and said second user device; a server connected to said network, said server having: a database storing user data of every user, said user data including i) a professional profile of each user, ii) relationship capital data comprising information about exchange of favors within the system; and said server calculating a favor balance from the relationship capital data; and said server transmitting display information about the favor balance to the first user interface device and the second user interface device.

7. The system of claim 6 which further comprises: a communication system for a user to request a favor from another user and use that system to accept, decline, negotiate alternatives, and indicate completion.

8. The system of claim 6 which further comprises: the display of the favor status based on the user actions in the favor exchange process.

9. The system of claim 6 which further comprises: the display of numbers of favors given, received and the favor balance.

10. The system of claim 6 which further comprises: the display of quantitative feedback metrics based on feedback given on the exchange of favors.

11. A web service for integrating a web-based application for exchanging and recognizing favors into an existing social networking service, comprising: a server connected to a network having programming to provide favor exchange and recognition information which comprises favor exchange data (e.g. favors given, favors received, favor balance and positive feedback) to one or more social networking services, wherein the web service acts as a central favor recognition bank and feedback consolidator.

12. The web service of claim 14, wherein the social networking service is selected from LinkedIn, Friendster, Xing, Face Book, and My Space.
